(19) United States
(12) Patent Application Publication
(10) Pub. No.: US 2009/0287514 A1
(43) Pub. Date: Nov. 19, 2009

(54) RAPID CANDIDATE OPT-IN CONFIRMATION SYSTEM

(75) Inventor: Stephen West, Raleigh, NC (US)

Correspondence Address: Marcia Moy;Alliance of Professionals & Consultants, Inc., 9201 Leesville Road, Suite 201, Raliegh, NC, 27613, US

(73) Assignee: Alliance of Professionals & Consultants, Inc., Raleigh, NC (US)

(21) Appl. No.: 12/047,875

(22) Filed: Mar. 13, 2008

Related U.S. Application Data
(60) Provisional application No. 60/918,344, filed on Mar. 16, 2007.

(51) Int. Cl. G06Q 10/00; G06F 17/30; H04M 1/64

(52) U.S. Cl. 705/7; 707/5; 379/88.04; 707/E17.109

(57) ABSTRACT

A recruiting system and method includes an automated candidate opt-in confirmation system for identifying and screening job candidate resumes that permits at least one potential candidate to opt-in to seek a job opportunity. The recruiting system enables a candidate to opt-in using a telephone, the Internet, or through any other suitable mediums or methods. The recruiting system and method provides a highly effective tool for job recruiters to select and identify qualified candidates that want to pursue a specified job opportunity quickly and efficiently.

### RELATED APPLICATIONS

This application claims the benefit of U.S. Provisional Patent Application Ser. No. 60/918,344 entitled “Rapid Candidate Opt-In Confirmation System” and filed on Mar. 16, 2007, the entire contents of which is hereby incorporated by reference.

### BACKGROUND

Current related systems are primarily related to resume search tools. Resume search tools offer the ability to track data on job applicants, to search resume databases, or a combination of both to identify potentially viable candidates. Resume search tools often generate very large quantities of potentially relevant resumes, typically numbering in the thousands per search. The larger the resume database searched, the greater the opportunity the resume search tool will generate a larger number of potentially relevant resumes. Typically, a search executed on fee-based job boards (e.g. Monster.com, Dice.com, or Computerjobs.com) usually generates thousands of potentially relevant resumes.

A job recruiter uses the generated potentially relevant resumes to find candidates to fill a specific job opportunity. The more resumes generated, the greater the likelihood of the recruiter finding an “excellent fit” candidate match to the job opportunity. If the resume search tool(s) generated a very large quantity of resumes, the recruiter must sift through all of the potentially relevant resumes. If the recruiter works with a large quantity of potentially relevant resumes, it can take the recruiter several days or weeks to adequately prioritize the generated resumes which should be selected for further consideration. The recruiter must contact all of the selected candidates to establish each candidate's current availability and willingness to accept the specific job opportunity. Additionally, if the candidate is available and willing, the recruiter may interview and/or test the candidate to better validate the candidate's fit and viability with the job opportunity.

The longer it takes for a recruiter to review a list of potentially relevant candidates, the more it costs to place a candidate at a job opportunity. Therefore, a need exists in the art of candidate selection and job matching that is more efficient and automated to lessen the time required and lower the cost of candidate placement at job opportunities.

### SUMMARY

In one aspect, a recruiting system is provided that comprises a method for determining relevant candidates for at least one job opportunity. In one embodiment, the method includes, generating at least one first pool of potentially viable candidates based on a comparison between at least one job opportunity and candidate resumes, wherein the job opportunity includes at least one job criterion, selecting and contacting at least one candidate from the at least one first pool of potentially viable candidates, enabling the at least one selected potentially viable candidate to opt-in to receive information about the at least one job opportunity, adding the at least one selected candidate to a second pool of willing and available candidates if the selected potentially viable candidate opts to receive more information about the at least one job opportunity. In one embodiment, the method further includes repeating steps of determining, generating, selecting and contacting, enabling, and adding until each candidate in the at least one first pool of potentially viable candidates is contacted at least once.

In another embodiment, the method comprises enabling each candidate in the second pool of candidates to undergo at least one verification process to determine if the candidates are qualified candidates for the job opportunity. In this embodiment, the at least one verification process includes enabling the candidates to verify information on the candidate. In an alternative embodiment, the at least one verification process includes enabling the candidates to participate in a test of knowledge. In another alternative embodiment, the test of knowledge is based on job requirements associated with the job opportunity. In one embodiment, the method further includes adding each candidate that passed the at least one verification process to a third pool of qualified candidates.

In one embodiment, the pool of potentially viable candidates is generated from searching at least one data collection. In one embodiment, the data collection is at least one database. In one embodiment, the at least one database is accessed over a network. In one embodiment, the method further includes determining and storing at least a portion of a candidate's resume from the at least one data collection.

In another embodiment of the method, the job opportunity is selected from at least one data collection. In one alternative embodiment, the data collection is at least one database. In one embodiment, the at least one database is accessed over a network. In one embodiment of the method, the job opportunity is selected from one of the following: a) at least one publicly accessible job database, b) at least one privately accessible job database, and c) a combination of at least one publicly accessible job database and at least one privately accessible job database.

In yet another embodiment of the method, the at least one candidate is contacted by telephone. In one embodiment, the method further includes permitting or enabling the candidate to opt-in for more information by performing one of the following: a) selecting a predetermined button on the telephone, and b) providing a predetermined voice response over the telephone.

In another alternative embodiment of the method, the at least one candidate may be contacted by email. In one embodiment, the method further includes permitting or enabling the candidate to opt-in for more information by performing one of the following: a) sending an email reply, and b) visiting a website and requesting additional information.

In one embodiment, a system for determining relevant candidates for at least one job opportunity includes a job agent, wherein the job agent selects at least one job opportunity, wherein the job opportunity is associated with at least one job criterion, a job candidate selection agent, wherein the candidate selection agent generates at least one first pool of qualified job candidates based on the at least one criterion of the selected at least one job opportunity, an opt-in confirmation agent, wherein the opt-in confirmation agent contacts at least one job candidate from the at least one first pool of potentially viable job candidates and enables the at least one contacted job candidate to opt-in to receive additional information about the at least one job opportunity, wherein the opt-in confirmation agent adds each potentially viable job candidate that opted-in to a second pool of available and willing job candidates, and a report agent, wherein the report agent generates at least one report based on the job candidates that form the second pool of available and willing job candidates.

Additional features and advantages are described herein, and will be apparent from the following Detailed Description and the figures.

### BRIEF DESCRIPTION OF THE FIGURES

FIG. 1 is a diagram illustrating a process for selecting viable candidates in accordance with one embodiment of the present invention.

FIG. 2 is a diagram illustrating system components used for matching viable job candidates with job opportunities in accordance with one embodiment of the present invention.

FIG. 3 is a flow diagram illustrating a process for determination whether a job candidate will be profitable to recruit in accordance with one embodiment of the present invention.

FIG. 4 is a flow diagram illustrating one process for matching viable job candidates with job opportunities in accordance with one embodiment of the present invention.

FIG. 5 is a flow diagram illustrating one process flow for narrowing pools of candidates that match with at least one job opportunity in accordance with one embodiment of the present invention.

### DETAILED DESCRIPTION

One embodiment of the recruiting system and method of the present invention relates to field of job placement and candidate recruiting. The recruiting system provides a novel method for screening and selecting viable job candidates from a pool of job candidates for a job opportunity. The recruiting system provides a user/operator (i.e., a recruiting professional) that is capable of selecting the most appropriate candidates suited for the job opportunity quickly and efficiently. The recruiting system reduces and/or minimizes the time needed for a recruiting professional to screen a large number of candidates because the recruiting system is capable of prescreening a pool of candidates that have identified an interest in the job opportunity based the job's criteria. A job's criteria may include, for example, pay scale, educational requirements, special skill sets, and the like.

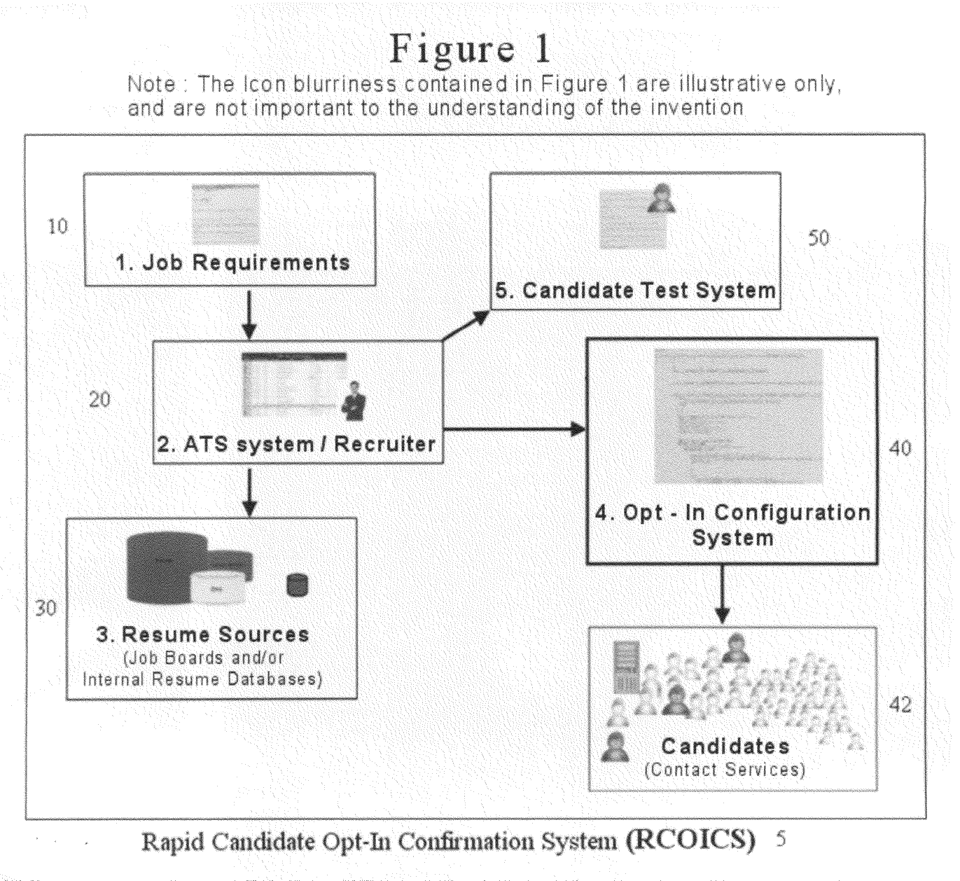

In one embodiment as illustrated in FIG. 1, rapid candidate opt-in confirmations system (RCOICS) 5 rapidly and automatically screens a pool of candidates for at least one job opportunity. In one embodiment, RCOICS 5 obtains job requirements by identifying at least one job opportunity published on at least one network accessible site and determines at least one job requirement associated with the at least one job opportunity as shown in block 10. In one embodiment, RCOICS 5 provides any determined job information to an applicant tracking system (ATS)/recruiter as shown in block 20. In one embodiment, RCOICS 5 searches for and retrieves potential candidates based on the at least one job requirement through the ATS/recruiter as shown in block 30. In another embodiment, RCOICS 5 contacts selected potential candidates about the job opportunity as shown in block 40 and 42. In one embodiment, RCOICS 5 permits and/or enables the contacted candidates to opt-in as available and willing to receive further information about the job opportunity or pursue the job opportunity through a rapid candidate opt-in confirmation system. The candidates that opt-in are added to a smaller pool of available and willing candidates. In one embodiment, if the candidates opt to receive further information about the job opportunity, RCOICS 5 further screens the candidates with at least one verification process to further validate the available and willing candidates as shown in block 50. Based on the verification process, RCOICS 5 generates another screened list or screened pool of viable qualified candidates that are interested in pursuing the job opportunity. RCOICS 5 therefore provides a list of the most relevant viable candidates for a specific job opportunity without the necessity of a recruiter contacting each candidate that was initially identified as a potential candidate for the job.

### Job Selection Agent

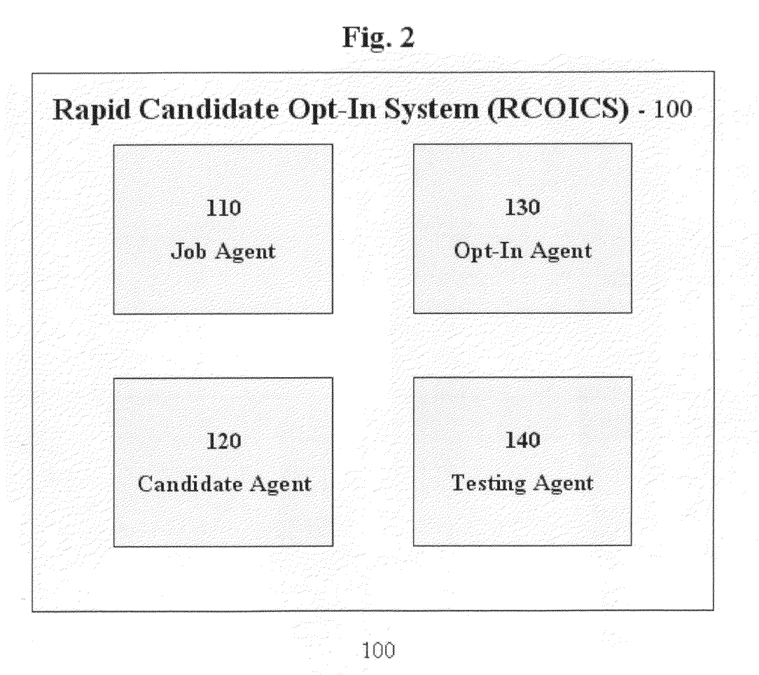

Turning now to FIG. 2, one embodiment of the components or subsystems of a rapid candidate opt-in confirmation system RCOICS 100 is illustrated. In one embodiment, RCOICS 100 obtains or determines at least one job opportunity through a job selection subsystem such as job agent 110. In one embodiment, the job opportunity is published on at least one network accessible location. However, in one embodiment, a user can manually provide job agent 110 details related to a job opportunity. In one embodiment, the details of a job opportunity can include information like pay rate, required prior experience, job location, and/or other skills; however, it should be appreciated that any suitable job attribute can be provided. It should also be appreciated that in one embodiment, job agent 110 can obtain details of a job opportunity in any suitable automated manner (e.g., from a pop-mail listener, a web crawler, or through data exchange systems using HR-XML).

In some embodiments, job agent 110 is an automated system that can quickly and accurately find at least one job opportunity. Many large firms publish jobs into web based Vendor Management Systems (VMS). The VMSs are designed for people to read about the job opportunities and the associated job requirements. The VMSs typically offer a computerized data exchange method to provide a large quantity of job opportunities. Thus, an automated system for parsing through all of the job opportunities is highly desirable, both from the speed of obtaining new jobs, the accuracy of finding all new jobs, and the ability to import and validate the information associated with the job opportunity. Thus, in one embodiment, job agent 110 gathers and consolidates all of the information contained within at least one job opportunity.

In one embodiment, once job agent 110 selected at least one job opportunity, job agent 110 writes/uploads at least one descriptor (i.e., a job requirement or criteria) of the job opportunity to a data collection. In one embodiment, the data collection is a relational database; however it should be appreciated that any suitable data storage can be used (e.g., the data on job opportunities can be stored in flat files like comma separated value files, spreadsheets, XML files, etc.). It should be appreciated that in some embodiments, a user (i.e., a recruiter) can manually store information about a job opportunity in any suitable manner in the same database used by job agent 110. In one embodiment, job agent 110 writes data about the job opportunity to the database using SQL; however, it should be appreciated that any suitable method can be used to write to the database. In one embodiment, the at least one descriptor for the job opportunity is written into a database that stores candidate information such as an applicant tracking system (ATS); however, the database storing the job opportunity can be separate from the database that stores candidate information. In one embodiment, the information stored about the job opportunity is used to match at least one candidate that has skills needed for the job opportunity. In one embodiment, the data collection created by job agent 110 is accessible by any component or subcomponent of RCOICS 100. It should also be appreciated that in one embodiment, any data collected by any component/subcomponent of the RCOICS 100 is accessible by any component of RCOICS 100. Alternatively, in one embodiment, at least some data has access restricted to predetermined components/subcomponents of RCOICS 100.

In one embodiment, job agent 110 is a web crawler such as a web spider. In one embodiment, the spider can be written and designed in Visual Basic (VB); however it should be appreciated that the spider can be written in any suitable programming language. In one embodiment, the spider's main component is Microsoft's Internet Explorer™ (IE); however it should be appreciated that the spider can use any software component suitable for requesting and rending network based content. In one embodiment, the spider sends commands to IE to navigate to uniform resource locators (URLs), post data to URLs, or to follow web based hyperlinks. In one embodiment, IE provides to the spider the webpage content (e.g., the user visible webpage content and webpage rendering instructions/code such as Hypertext Markup Language (HTML)); however it should be appreciated that the rendering instruction can include any suitable language such as Javascript, Perl, JAVA™, Adobe Flash™. In one embodiment, the provided HTML and webpage content is parsed for specific data associated with at least one job opportunity. In one embodiment, the spider parses basic data blocks such as company, hiring manager, job description, and contact information; however it should be appreciated that the spider can parse any level/amount of data from the webpage content.

In one embodiment, where job agent 110 incorporates IE, several methods are available for gathering information on job opportunities. In one embodiment, IE can be instructed to select a webpage link to a job opportunity using: 1. Inner Text; 2. ID tag; or 3. Sending tab and a return commands.

In one embodiment where job agent 110 incorporates IE, job agent 110 can instruct the IE software component to navigate/retrieve pages based on inner text. That is, IE will navigate/retrieve from a first page, an additional particular page based on a page identifier (e.g., additional pages are identified on the first page by some defined number like 2, 3, 4, 5, etc.); however, it should be appreciated that any suitable page identifier can be used. If the additional page identifiers are known, job agent 110 can instruct the IE software component to navigate/retrieve content associated with a link having an inner text of “2” for the second page from the first page. However, in one embodiment, if “2” appears elsewhere in the webpage, but does not advance to page two, then the inner text of the link may not be an appropriate method for navigation.

In one embodiment where job agent 110 incorporates IE, job agent 110 can instruct the IE software component to navigate/retrieve pages based on ID tags. An ID tag can be used if the link is crafted with a unique ID tag, for example, “<a id=page2 href=page2.htm>2</a>”. However, ID's are optional and in most cases not used by the developers when building a site.

In one embodiment where job agent 110 incorporates IE, job agent 110 can instruct the IE software component to navigate/retrieve pages based on job agent 110 replicating sending tabs and a return from a keyboard. In one embodiment, sending tabs makes each hyperlinked element in a webpage the active element on a page in order of the tab index or derived tab index where none are specified. In one embodiment, to select the active element, a return command is sent to the browser. This is a last resort method, as this method of selection is based on the index of elements prior to run time. If a webpage is a polymorphic page, the results can be unpredictable. This method has further challenges because the method for sending a key press command in VB 6.0 is sendkeys ([key ASCII]). As a result, the key press command may be sent from the keyboard and, thus, to an active window in the operating system (which may not be the spider). In one embodiment, a Microsoft Windows™ API function call can be used to send mouse and keyboard commands, including key presses directly to a specific application handle. In one embodiment, the resultant URL or webpage content can be analyzed to determine if the correct result was obtained for navigation. In one embodiment, if new links have caused inappropriate navigation, job agent 110 can invoke an algorithm for finding and learning the new tab index of the desired link. Thus, in one embodiment, job agent 110 can learn and fix the navigation if a change occurs in the website it is crawling (many of which are polymorphic in nature). In one embodiment, job agent 110 can incorporate direct navigation as a method for retrieving data. However, it is should be appreciated, that any suitable method for navigating links in webpage content can be implemented.

In one embodiment, RCOICS 100 includes a job requirements parser subcomponent. In an alternative embodiment, the job requirement parser is a subcomponent of job agent 110. In one embodiment, the job requirement parser processes job opportunity data extracted by job agent 110. That is, in one embodiment, once job agent 110 retrieves at least one job opportunity, job agent 110 passes all of the information about the retrieved at least one job opportunity to the job requirement parser. Job requirement parser then separates (i.e., processes) each job detail of at least one retrieved job opportunity. In one embodiment, job requirement parser writes or uploads the processed data about the at least one job opportunity to at least one database of job opportunities as described above.

In one alternative embodiment, job agent 110 writes or uploads retrieved job opportunities to a database as described above. At any suitable time thereafter, job requirements parser accesses the data about the retrieved job opportunities from the database and processes the data.

In one embodiment, job requirement parser separates information about job opportunities pulled from a plurality of different sources of job opportunities. Postings of job opportunities from different sources are often published in different formats. However, job requirement parser can process job opportunities from a plurality of different sources even if the job opportunities are published in a plurality of disparate formats.

In one embodiment, the job requirement parser of RCOICS 100 processes (i.e., separates) information about the job opportunity. That is, the processing extracts items of interest from the job opportunity related to searching for a qualified resume. In one embodiment, the items of interest are job location, pay rate, skills, abilities, experience, and education. However, it should be appreciated that any suitable information about the job opportunity can be processed and stored in the database.

In one embodiment, the job requirement parser extracts a job location requirement for the job opportunity. In one embodiment, the job location uses a postal code for the city and state lookup, which is also mapped to lines of longitude and latitude. In one embodiment, any suitable detail about the job location can be extracted from the job opportunity such as a building number and a street address.

In one embodiment, job requirement parser extracts a pay rate requirement from the job opportunity. The pay rate is the amount of money a company that advertised a job opportunity is willing to pay for a candidate that meets the job opportunity requirements. In one embodiment, the pay rate includes the profit a recruiting company can make for placing a candidate at the job opportunity as well as the amount of money that is paid to the candidate. In one embodiment, the pay rate is determined as an hourly rate. However, it should be appreciated that the pay rate can be based on any suitable periodic compensation rate such as a monthly rate, a yearly rate, or a flat rate based on the work performed.

In one embodiment, job requirement parser extracts at least one skill or ability (hereafter “skill” or “skills”) requirement from the job opportunity. In one embodiment, skills are extracted from the job opportunity by searching for skills using successive searches with at least one delimiter character. That is, a publication of a job opportunity may list a plurality of different skills and separate the skills based on commas or semicolons (e.g. C++, VB; Perl). Thus, in one embodiment, job requirement parser may require more than one search of a particular set of required skills data because the required skills may be separated by different delimiting characters such as spaces, semicolons, commas, bullets, and periods. However, it should be appreciated, that in one embodiment, the skills extraction does not require extraction based on delimiters. In one embodiment, each listed skill may be separately stored in a database field. Thus, in this embodiment, job requirement parser executes an SQL call to retrieve at least one of the associated skills from a database.

In one embodiment, job requirement parser incorporates predetermined synonyms, frequently used synonyms, or user defined synonyms for determining what skills a job opportunity required. That is, in one embodiment, a “DBA”, is equivalent to a “database admin”, a “database administrator”, a “DB Admin”, a “data architect”, or a “MS-SQL Admin”. Thus, if job requirement parser extracts a skill listed as a “DBA”, in one embodiment, job requirement parser can determine that the job opportunity requires a database administrator. It should be appreciated that in one embodiment, any suitable number of synonyms can be defined for any suitable skill requirement.

In one embodiment, job requirement parser is preprogrammed with different synonyms for particular skills extracted from job opportunities. In one embodiment, job requirement parser is programmed to “learn” different synonyms for skills extracted from job opportunities. That is, job requirement parser can identify a frequently extracted skill description that is not known. In this embodiment, job requirement parser can require input from a user of RCOICS 100 to identify and associate a previously known skill description as synonymous with the new skill description. In one embodiment, job requirement parser does not require any user input and creates a new skill description based on the frequency that the extracted skill appears in job opportunities. In one embodiment, a user of RCOICS 100 can add new skill description synonyms for any suitable known skill or new skill at any suitable time.

In one embodiment, job requirement parser extracts at least one experience requirement from the job opportunity. In one embodiment, the experience requirement is a range of years; however, job requirement parser can extract any suitable description of a job opportunity's experience requirement.

In one embodiment, job requirement parser extracts at least one education requirement from the job opportunity. In one embodiment, the education requirement is a range of years of school attended; however, job requirement parser can extract any suitable description of a job opportunity's education requirement.

It should thus be appreciated that in one embodiment, job agent 110 monitors, captures and maps data from job opportunities posted on network based systems or from vendor management systems.

### Candidate Selection Agent (ATS/Recruiter)

In one embodiment, RCOICS 100 includes candidate agent 120. Candidate agent 120 is configured to search and retrieve at least one resume of at least one potential job candidate; however candidate agent 120 can search and retrieve any suitable number of resumes. In one embodiment, candidate agent 120 is configured to parse candidate information in the searched and retrieved resumes that include candidate information that match with the requirements of a job opportunity parsed by job agent 110. Candidate agent 120 creates a pool of potentially viable candidates that match job requirements.

In one embodiment, a user provides at least one job opportunity and any associated job requirements to candidate agent 120. In one embodiment, a user selects a job opportunity previously extracted by job agent 110. Based on the job selection, candidate agent 120 retrieves any job requirements stored with RCOICS 100. In one embodiment, the user manually enters at least one job opportunity and any associated job requirements into candidate agent 120 in any suitable manner (e.g., through an entry screen). In one embodiment, candidate agent 120 creates an initial search template (i.e., an initial set of search instructions) based on the selected job opportunity and associated requirements. In one embodiment, the initial search template indicates to the user that candidate agent 120 is configured to search for resumes that have at least one skill that matches a job requirement of the selected job opportunity.

In one embodiment, candidate agent 120 does not require any additional information and can perform a search for resumes. However, it should be appreciated that in one embodiment, candidate agent 120 can enable the user to modify the search criteria in the initial search template. For example, in one embodiment, candidate agent 120 enables a user to modify the initial search template to specify a specific search criterion such as the maximum number of potential candidates to retrieve. In another embodiment, candidate agent 120 enables a user to modify the initial search template to search specific databases for resumes. However, it should be appreciated that any suitable search criteria can be added or removed from the search template to drive candidate agent 120's resume search for potential candidates.

In one embodiment, candidate agent 120 can automatically modify the search criteria until the maximum number of candidates is retrieved. In one embodiment, candidate agent 120 enables the user to manually modify the search criteria until the maximum number of potential candidates is obtained. In one embodiment, candidate agent 120 can execute a plurality of concurrent resume searches with different variations of the search scope and select the resume search that provides the maximum number of potential candidates. In one alternative embodiment, candidate agent 120 enables a user to manually create a list of potential candidates to send to a call agent subcomponent as discussed below.

In one embodiment, once candidate agent 120 is configured with a search template for at least one job opportunity, candidate agent 120 is configured to search for resumes that match at least one criterion in the search template. In one embodiment, candidate agent 120 can access and retrieve resumes from any suitable resume data collection such as local or web based resume databases in any suitable manner. In one embodiment, candidate agent 120 accesses and retrieves resumes similar to the methods described above with job agent 110 (i.e., using a web crawler or through the job requirements parser). In one embodiment, candidate agent 120 searches and retrieves resumes from free or fee based network accessible job boards. In one embodiment, candidate agent 120 directly accesses and retrieves resumes from at least one network based job boards through network exposed application programming interfaces (APIs). In one embodiment, candidate agent 120 accesses and retrieves resumes from job boards that structure/format resumes with custom or open standard XML structures (e.g., the HR-XML structure, created by a consortium that defined a structure for storing resume data).

In one embodiment, candidate agent 120 searches the job boards in real time through network services such as the Internet. Thus, candidate agent 120 can quickly search many available job boards for all relevant resumes. Furthermore, if a candidate is actively entering a resume into a job board, the resume is instantly available.

In one embodiment, candidate agent 120 searches a local resume database such as a database of resumes kept by RCOICS 100. In one embodiment, past resume searches produced one or more potentially viable candidates. In one embodiment, resume data on these candidates are stored for a predetermined period of time. RCOICS 100 can be configured to store additional data about the candidates such as whether the candidate was successfully placed at a job opportunity or if the candidate was continuously successful at a current or previous job. That is, candidate agent 120 includes, as part of the search, candidates with proven performance and skills that are on another job that RCOICS 100 knows will end soon or has already ended.

In one embodiment, candidate agent 120 includes at least one subcomponent. In one embodiment, candidate agent 120 includes a commercial database search subcomponent that enables candidate agent 120 to query at least one network based commercial resume collection for resumes (e.g., Monster™ or CareerBuilder™). In one embodiment, the commercial database search subcomponent can search any suitable number of commercial databases based on the search template. In one embodiment, the commercial database search subcomponent searches, retrieves, and stores information regarding jobs, companies, contacts, resume, candidates, and recruiting activities into its own database or into a database associated with RCOICS 100. In one embodiment, the commercial database search subcomponent includes search integration through network available Internet services. In one embodiment, candidate agent 120 accesses the network available services through a Virtual Private Network (VPN). It should be appreciated that any suitable commercial database search subcomponent can be incorporated into candidate agent 120.

It should therefore be appreciated that in one embodiment, candidate agent 120 can maximize the number of data sources searched.

In one embodiment, regardless of how the resume data is accessed or the structure of the resume data, candidate agent 120 generates (i.e., searches and retrieves) a pool of resumes that include at least one matching criteria specified in the initial search template; however, any suitable number of matching search criteria can be used to generate a pool of potentially viable resumes (i.e., potentially viable candidates). In one embodiment, job agent 110 provides at least one search criteria for candidate agent 120 to determine what resumes to add to a pool of potential candidates. If candidate agent 120 searched at least one major job board, the search could produce thousands of resumes matching the at least one search criteria; however, in one embodiment, candidate agent 120 can automatically restrict the resumes collected with an increasingly narrow recursive search based on search criteria such as minimum pay rate, geography, skills, and experience. Thus, in this embodiment, candidate agent 120 can generate a more defined number of potential candidates that match at least one search criteria of the at least one job opportunity.

In one embodiment, candidate agent 120 may initially retrieve a search based on a broad search template. If the number of retrieved resumes is too large, candidate agent 120 can automatically narrow the initially retrieved resumes based on additional criteria associated with the job opportunity. In one embodiment, the criteria may not be associated with the job opportunity, but based on any suitable data points known to produce potentially viable candidates. Alternatively, in one embodiment, candidate agent 120 enables a user to manually alter the list of retrieved resumes by adding or subtracting any suitable criteria and applying the new search template to the retrieved resumes; however, it should be appreciated that candidate agent 120 can execute a new search based on the altered search template.

In one embodiment, candidate agent 120 is configured to search for potentially viable candidates based on job skills criteria. In one embodiment, candidate agent 120 extracts a candidate's skills from a selected resume. As described above with respect to extracting skills from a published job opportunity, candidate agent 120 may need to use a variety of methods to extract skills from a resume. For example, one resume may group skills together in short delimited descriptions such as C++, Perl, SQL. On the other hand, one resume includes a candidate's skills embedded inside one or more brief narratives of the candidate's different duties at prior jobs. Further, a candidate might use one of several different ways to describe a skill (e.g., synonyms, as discussed above with the job skills). Thus, in one embodiment, candidate agent 120 determines what skills are listed on a candidates' resume and determines what type of skill is listed based on variations in the skill's name. In one embodiment, after candidate agent 120 extracts a candidate's skills from the candidate's resume, candidate agent 120 determines if at least one skill criteria for the job opportunity matches with at least one of the candidate's listed skills. In one embodiment, candidate agent 120 may require that any suitable number skills match before the candidate is added to a pool of potential candidates.

In one embodiment, candidate agent 120 is configured to search for potential candidates based on job location criteria. In one embodiment, candidate agent 120 extracts the location of the candidate from a selected resume. Candidate agent 120 applies the haversine formula based on the location of the candidate and the location of the job opportunity to determine how far a candidate is from a job opportunity. In one embodiment, if the job opportunity criteria restricts where a person can live and still be qualified for the job opportunity, candidate agent 120 can reject the resume if the candidate does not meet the location requirement. However, it should be appreciated that in one embodiment, job location criteria and the distance a candidate is living from the job opportunity are not critical to filling the job opportunity. In another example, the selected resume may indicate that the candidate is willing to relocate, thus the candidate may be potentially viable for the job even if the candidate is located 1000 miles from the job opportunity.

In one embodiment, candidate agent 120 is configured to search for potential candidates based on a pay rate criteria. For example, determining whether placing a candidate will be profitable if a resume indicates a pay rate plus other associated factors (see below for examples) that are higher than a job opportunity's offered billing rate, the resume is rejected. However, it should be appreciated, that the pay rates are negotiable, thus, candidate agent 120 can be configured to match a pay rate that is within a predetermine range. In one embodiment candidate agent 120 calculates a billing rate based on the candidate's required pay rate. In one embodiment, the pay rate function is used to ensure that the pay rate offered to the candidate is profitable for the company recruiting the candidate. In one embodiment, the pay rate is dependant on a number of factors such as client bill rate, tax rates, benefit rates, average tenure discount over an estimated contract term, VMS service fees, and general and administrative costs (G&A). However, any suitable factors can be incorporated into determining the pay rate.

In one embodiment, candidate agent 120 is configured to recursively search through the pool of candidates by applying increasingly restrictive search criteria aimed at returning a smaller pool of potentially viable candidates until the best potentially viable candidates are found.

Turning to FIG. 2, in one preferred embodiment, candidate agent 120 determines whether a candidate will be profitable if placed at a job opportunity. In one embodiment, the following definitions apply to calculating a candidate's pay rate:

G&A (General and Administrative Costs): This covers salary, lighting, heating, and general costs of running a back office and support structure.

Tenure Discount: Tenure discount is a discount applied to the candidate billing rate that reduces the billing rate based on the length of time a recruiting contract has been in place. Profit markup is often reduced if the contract term exceeds a certain term. Thus, a contract term can be a factor in determining profits. Tenure Discount rates are specific to terms and conditions for specific clients with job opportunities.

VMS Fee: Some clients use a vendor management system (VMS) that handles the administrative process for recruitment engagements. A VMS may apply a fee to a recruiter for use of the VMS, thus the recruiter must take into account this fee when calculating the maximum pay rate payable to a candidate.

Gross Margin: The amount of money left over after paying the candidate as well as the direct costs associated with the candidate such as taxes and benefits. Gross margin does not include G&A, VMS Fees, commissions to recruiters and sales staff.

Profit: The amount of money left over from gross margin after applying G&A and associated fees such as VMS Fees, and commissions to sales staff and recruiters.

At block 200, candidate agent 120 determines a billing rate and whether other associated costs are specified. At block 210, candidate agent 120 applies default rates to the associated costs if no associated costs are defined at block 200. At block 220, candidate agent 120 calculates a pay rate. In one embodiment, the pay rate is determined in terms of an hourly rate such as: HourlyRate=BillRate−((Billrate×(G&A+VMSFee+TenureDiscount)+AdditionalBenefitCosts+Profit)). At block 230, candidate agent 120 reduces the amount determined in block 220 by $0.01; however, any suitable number can be used to decrement the amount determined in block 220. At block 240, candidate agent 120 retrieves tax rate and benefit rates which are based on the pay rate calculated in block 220. At block 250, candidate agent 120 calculates a gross margin as: GrossMargin=BillRate−(HourlyRate+AdditionalBenefitCosts+(HourlyRate×(TaxRate+BenRate))). At block 260, candidate agent 120 calculates the profit produced if the candidate was placed at the job opportunity at the candidate's billing rate. In one embodiment, profit is calculated as profit before a tenure discount is applied and profit after a tenure discount is applied. In one embodiment, ProfitPriorToTenureDiscount=GrossMargin−(Billrate×(G&A+VMSFee)) and ProfitAfterMaxTenureDiscount=ProfitPriorToTenureDiscount−(Billrate×TenureDiscount). At block 270, candidate agent 120 determines whether the calculated profit is greater or equal to zero. If the profit is less than or equal to zero, the candidate agent 120 returns to block 230 and the pay rate is decremented. In one embodiment, candidate agent 120 repeats blocks 230 through 270 to search for a pay rate breakeven point of placement of the candidate at the job opportunity. If candidate agent 120 determines that the calculated profit is greater than or equal to zero, candidate agent 120 compares the determined pay rate to the candidate's required billing rate. If the pay rate is greater than or equal to the candidate's required billing rate, candidate agent 120 adds the resume to the pool of qualified candidates.

In an alternative embodiment, billing rate can be calculated by adding a candidate's required pay rate to a predetermined percentage of the candidate's required pay rate. For example, if the gross profit margin on a candidate is 10%, then billing rate=candidate's required pay rate+(0.10×candidate's required pay rate). However, it should be appreciated that the pay rate can be determined in any suitable manner based on a recruiting company's expected profit for matching a candidate with a job opportunity.

In one embodiment, candidate agent 120 is configured to search for qualified candidates based on experience criteria. In one embodiment, candidate agent 120 estimates experience for a candidate by parsing the resume for dates the candidate was employed and adds the elapsed time together. In one embodiment, candidate agent 120 is also configured to search for qualified candidates based on an educational criteria. In one embodiment, candidate agent 120 is also configured to extract contact information for the candidate from a selected resume. In one embodiment, candidate agent 120 extracts contact information like a phone number, email address, or mailing address so that RCOICS 100 can contact the candidate if the candidate is added to the list of potentially viable candidates.

As described above, in one embodiment, RCOICS 100 includes search templates. In one embodiment, candidate agent 120 can be preconfigured with search templates based on criteria such as skills (e.g., a search template preconfigured to find a candidate that is proficient in a plurality of relational databases). If a user (i.e., a recruiter) specializes in working with candidates having at least one specific skill, the user may perform a resume search incorporating the specific skill each time a search is performed. Thus, candidate agent 120 can provide a search template to include at least one skill criteria and prevent the user from having to enter the often used skill each time a search is performed. In one embodiment, RCOICS 100 enables the user to create at least one search template that includes at least one predefined skill to search.

In one embodiment, RCOICS 100 can learn over time that the user frequently searches for people having a specific skill and create a preconfigured resume search template for the user. In one embodiment, if the user searches for at least one particular skill over a predetermined threshold number times, RCOICS 100 automatically adds the at least one specific skill to a list of skills associated with the user. In one embodiment, the threshold is between 0 and any suitable number. In one embodiment, if the threshold level is reached, RCOICS 100 adds the specific skill into the initial predefined search template for the user. In one embodiment, if the user removes the skill from the predefined search template, RCOICS 100 removes the skill from the user's predefined search template. However, in one embodiment, if the user removes the skill from the predefined search template, RCOICS 100 does not remove the skill from the user's predefined search template, rather, RCOICS 100 reduces the weight of the deleted skill. In one embodiment, RCOICS 100 continues to lower the weight of the deleted skill each time the user deletes the skill from the user's predefined search template. If the weight of the skill reaches a predefined threshold between 0 and any suitable number, RCOICS 100 permanently deletes the skill from the user's predefined template. Thus, in one embodiment, the RCOICS 100 adjusts and learns a pattern of skill searching for a specific user.

In one embodiment, RCOICS 100 can create a global search template for more than one user. In one embodiment, if RCOICS 100 detects that at least one skill has reached a threshold for a user, the skill is available for that user as was described above. However, in one embodiment, if the at least one skill reached a threshold for more than one user, the skill is added to a global list of skills associate with a plurality of users. In one embodiment, skills on a global list of skills automatically appear on a predefined search template for a predetermined set of users. In one embodiment, skills on a global list of skills automatically appear on a predefined search template for all users. In one embodiment, if a skill is on a global list of skills, the skill is more difficult to delete from the global template. In one embodiment, RCOICS 100 tracks the number of times a skill is deleted from the global template and the number of users that delete the skill from the global template. If the number of times and the number of users that delete the skill from a global template reach a predetermined threshold, RCOICS 100 can remove the skill from the global search template. However, it should be appreciated that in one embodiment, RCOICS 100 can be configured to enable any suitable user to delete the skill on a global list of skills without waiting for the threshold to be reached.

In one embodiment RCOICS 100 automatically maintains a list of new and active skills in at least one database. In one embodiment, RCOICS 100 maintains the skills in any suitable data collection or database as described above. In one embodiment, the RCOICS 100 learns new skills over time. That is, candidate agent 120 adds new skills to the database based on the number of times a new skill is extracted from a resume. When the candidate agent 120 extracts skills from a resume, the recruiter/user is shown the result of the skills extraction and allowed to edit the skills. In one embodiment, a user of RCOICS 100 can add or remove skills to create a search template.

In one embodiment, RCOICS 100 maintains a status of skills stored in a database. In one embodiment, skills are tagged as active/inactive or new. In an alternative embodiment, skills are assigned a weight that enables RCOICS 100 to rank skills in terms of whether the skills are in demand or infrequently used. In one embodiment, if RCOICS 100 searches for a particular skill, the searched skill is tagged as active the database. In one embodiment, RCOICS 100 tags skills using a combination of both methods or in any suitable manner.

In one embodiment, if at least one new skill is added to the database in any suitable manner, the newly added skill is tagged as a new skill that RCOICS 100 is learning. If the new skills are searched or extracted from at least one resume again, RCOICS 100 provides a weight to the skills. In one embodiment, as the weight of the skill is increased, the skill can be elevated to list of the most popular skills. In one embodiment, the popular skills are automatically added to at least one preconfigured search template.

In one embodiment, each time a skill is used, candidate agent 120 timestamps the use and stores the timestamp in a database. In one embodiment, RCOICS 100 can periodically review the list of stored skills and eliminate the underutilized skills. If a particular skill has a time-stamp that is older than a predetermined threshold, RCOICS 100 can automatically delete the skill from any database that stores information about the skill and thus keep RCOICS 100's list of skills current with popular industry skills. In one embodiment, RCOICS 100 may ask a user before deleting skills that are determined to be out of date.

### Candidate Opt-in Confirmation Agent

In one embodiment, RCOICS 100 includes an opt-in agent 130 subcomponent. In one embodiment, opt-in agent 130 contacts at least one candidate from a pool of potentially viable candidates identified by candidate agent 120. In one embodiment, opt-in agent 130 provides pertinent information about a job opportunity to the candidate and asks the at least one candidate if the candidate would like to apply for or receive more information about a job opportunity. In one embodiment, opt-in agent 130 enables the candidate to opt-in for further consideration. In one embodiment, opt-in agent 130 creates a pool of available and willing candidates that opt-ed in for further consideration. Thus, it should be appreciated that opt-in agent 130 reduces the pool of potentially viable candidates identified by candidate agent 120.

In one embodiment, opt-in agent 130 is configured to contact at least one candidate by phone through the public switched telephone network (PSTN). The candidate is provided a description of the job opportunity and opt-in agent 130 asks the candidate to respond whether the candidate wishes to apply for the job opportunity or receive more information about the job opportunity. Opt-in agent 130 enables the candidate to respond over the phone using voice commands or by pressing at least one predetermine key on the telephone. However, it should be appreciated that opt-in agent 130 can be configured to contact candidates in any suitable manner such as through email or by generating mailings describing the job opportunity. In one alternative embodiment, opt-in agent 130 can contact candidates through chat clients and text messaging.

In one embodiment, before candidates are contacted, opt-in agent 130 must be configured with a call script (or e-mail script, depending on medium used to contact the candidates) for a particular job opportunity. In one embodiment, a call script contains details about a job opportunity and what pool of potentially viable candidates to contact about the job opportunity. In one embodiment, at least one part of the call scripts is predefined and not editable by a user, while at least one part of the call script is editable by the user. Alternatively, the entire call script can be edited by a user. In one embodiment, a call script is generated from a master call template. In one embodiment, opt-in agent 130 adds job and/or candidate information passed from candidate agent 120 to the master call template. However, in one embodiment, a opt-in agent 130 may not use a master call template.

In one embodiment, a call script can be associated with more than one pool of candidates. Thus, in one embodiment, opt-in agent 130 can be configured to contact plurality of different pools of candidates for at least one job opportunity. It should also be appreciated that a opt-in agent 130 may not require a call script before candidates are contacted. Thus, opt-in agent 130 can be configured to contact at least one pool of candidates in any suitable manner.

In one alternative embodiment, as described above, opt-in agent 130 can be configured with an e-mail script for contacting candidates. In one embodiment, the e-mail script is a backup mode for contacting candidates; however, in one embodiment, opt-in agent 130 can be configured with an e-mail script as a primary method of contacting candidates. Opt-in agent 130 can be configured with any other suitable contact scripts depending on the medium used to contact candidates.

In one embodiment, opt-in agent 130 includes 3^{rd} party contact services. In one embodiment, the 3^{rd} party contact services are enabled for Internet based services. Opt-in agent 130 is configured to send candidate lists and candidate messages to the 3^{rd} party contact service. In one embodiment, the messages are sound files; however any suitable message format can be passed to the 3^{rd} party contact service. The 3^{rd} party contact service contacts the list of candidates (e.g., in any suitable manner) with the predetermined messages and enables candidates to respond whether they are interested in applying for or hearing more information about the job opportunity. In one embodiment, the 3^{rd} party contact service can contact thousands of people in a matter of minutes. In one embodiment, the 3^{rd} party service can provide additional candidate screening/verification. In one embodiment, the 3^{rd} party service can provide a list of candidates to opt-in agent 130, thus RCOICS 100 can provide the list of candidates that opted-in to a user (i.e., a recruiter). In one embodiment, the 3^{rd} party contact service can provide a list of candidates that opted-in directly to a user.

In one embodiment, opt-in agent 130 does not use a 3^{rd} party contact service. In one embodiment, opt-in agent 130 includes a voice call system that can contact candidates over the PSTN and inquire whether candidates wish to opt-in for further consideration about a job opportunity. In one embodiment, the voice call system of opt-in agent 130 includes a personal computer (PC) with at least one telephony card, software to drive the telephony card, and a database of call scripts. It should be appreciated that any suitable combination of hardware and software can be used to contact candidates.

In one embodiment, opt-in agent 130 is configured with the PC and telephony card to concurrently call at least 4 candidates over the four separate phone lines connected to the PSTN. In one embodiment, opt-in agent 130 is configured with at least four telephony cards and is connected to the PSTN through 16 separate phone lines. In this embodiment, opt-in agent 130 can contact 1100 candidates an hour, by averaging 60 seconds per call. In contrast, an average recruiter can make about 15 contacts a day, or about 2 per hour. It should also be appreciated that any suitable number of PCs configured with any suitable number of telephony cards can be used to contact candidates about a job opportunity. It should also be appreciated that in one embodiment, the PC can be substituted with any suitable device such as specialized hardware.

In one embodiment, opt-in agent 130 is configured to use software to drive the telephony hardware (hereafter “phone software”). It should be appreciated, that any suitable phone software can be used to drive the telephony hardware. In one embodiment, the phone software used to drive the telephony hardware enables a user to visually build scripts to operate the telephony hardware. In one embodiment, the software used to drive the telephony hardware enables a user to create scripts/programs for the phone software through of flow charts that have integrated database queries. In one embodiment, the phone software used to drive the telephony hardware can be configured to detect key presses, answering machines, line status changes such as pickups and hang-ups, and no dial tone. In one embodiment, the phone software enables text to be converted to speech for communicating with the contacted candidates. In one embodiment, the phone software used to convert text to speech is separate from the software used to drive the phone dialing hardware. In one embodiment, opt-in agent 130 can be configured to use any suitable text-to-speech converter.

In one preferred embodiment, the phone software is configured to recognize a number of phone operating states and instructions. The following is a list of phone operating states and instructions:

IDLE is the default state of the call system.

IGNORED is a state of a candidate record. If a candidate record has been assigned IGNORED, opt-in agent 130 does not contact the candidate. No call activity can be assigned to this record until it is converted to IDLE status. IGNORED is a manual state set by a user.

QUEUED status is assigned to a candidate record and means that a record is under control of opt-in agent 130. After opt-in agent 130 contacts a candidate, opt-in agent 130 assigns QUEUED to the candidate record, meaning that the candidate should not be contacted. After a predetermined period of time has elapsed, RCOICS 100 removes the QUEUED status from the candidate record and places the candidate record into READY status.

READY status is assigned to a candidate record and instructs opt-in agent 130 to contact the candidate.

ACTIVE status is assigned to a candidate record and indicates that that opt-in agent 130 is currently contacting the candidate record.

NO PHONE status is assigned to a candidate record to indicate that that no phone was reached, the phone did not ring, or the line may be disconnected.

NO REPLY status is assigned to a candidate record to indicate that the phone kept ringing and the call attempt was abandoned.

PICKUP status is assigned to a candidate record and indicates that the candidate or a phone answering machine picked up the call. If PICKUP status is obtained, opt-in agent 130 provides the candidate (or answering machine) a message about the job opportunity and asks the candidate to press “1” (or provide any suitable response) to opt-in for more information or to apply for the job opportunity.

HANGUP status occurs at any time during a call if the call disconnects prior to one of the other statuses being made.

NO_CALL is a status assigned to a candidate record if the candidate indicates that they would like to be placed on a “Do not call list”. Opt-in agent 130 does not contact a candidate record assigned as NO_CALL.

MESSAGE status is assigned to a candidate record if opt-in agent 130 does not detect any responses to at least one question. Opt-in agent 130 can leave a message on the candidate's answering machine asking the candidate to contact the recruiter assigned to placing a candidate at a job opportunity.

RESPONSE_YES status is assigned to a candidate record that indicates that the candidate has opted-in and is willing and available to do the job described.

RESPONSE_NO status is assigned to a candidate record when a candidate indicates they do not wish to perform the job described.

RESPONSE_NONE status is assigned to a candidate record when a candidate fails to give any response and the call ends.

It should be appreciated that in one embodiment, the phone software can be configured to recognize any suitable call status and assign any suitable status to a candidate record.

In one embodiment, RCOICS 100 can provide the status of at least one call to a user (i.e., a recruiter). However, it should be appreciate that RCOICS 100 can provide the status of only calls where candidates opted-in, or the status of all in progress and completed calls to candidates; however, RCOICS 100 can provide any suitable number of status reports for calls to candidates. In one embodiment, RCOICS 100 displays the status/results in real time based on candidates' live key responses and call statuses in a web browser based output display. In one embodiment, RCOICS 100 displays the status/results of calls to candidates as at least one dynamic webpage that incorporates HTML, ASP, JavaScript, and AJAX. Alternatively, in one embodiment, RCOICS 100 provides a printed list of all candidates that opted-in. In one embodiment, RCOICS 100 stores the list of candidates that opted-in and is configured to enable a user to view the list of candidates at any suitable time.

### Candidate Verification System

In one embodiment RCOICS 100 may have identified a pool of available and willing candidates that opted-in to be considered for a job opportunity through opt-in agent 130. However, the pool of available and willing candidates that opted-in may still be too large for a recruiter to effectively manage. Thus, in one embodiment, RCOICS 100 can perform a further analysis of the pool of available and willing candidates to verify the skills, depth of knowledge, personality or background suitability, to determine which candidates are the best fit. In one embodiment, RCOICS 100 can recursively process the pool of candidates that opted-in through at least one test.

In one embodiment, RCOICS 100 includes test agent 140. In one embodiment, test agent 140 administers at least one test to at least one candidate from the pool of candidates that opted-in to determine if the candidate is qualified for the job opportunity. Thus, in one embodiment, RCOICS 100 reduces or at least ranks the number of qualified candidates that a recruiter must interview to determine the candidates that are the most qualified for the job opportunity. In one embodiment, test agent 140 tests each candidate from the pool of candidates that opted-in. In an alternative embodiment, each candidate from the pool of candidates that opted-in may not be further tested (i.e., candidate testing is optional).

In one embodiment, testing agent 140 performs general testing and/or specific testing of candidates. In one embodiment including a general test, testing agent 140 tests the personality of candidates. In one embodiment, testing agent 140 executes a background check on the pool of opted-in available and willing candidates. In one embodiment including a specific test, testing agent 140 tests the skills of the candidates. In one embodiment, the test includes a general skills test such as reading skills. In one embodiment, the test includes a specific skills test such as how to program in C++. It should be appreciated that any suitable test can be performed on the pool of opted-in candidates. In one embodiment, at least one test is available through a 3^{rd} party testing vendor. In one embodiment, the at least one test available through a 3^{rd} party testing vendor is provided though a network such as the Internet. However, the 3^{rd} party test can be provided in any suitable manner. In one embodiment incorporating a 3^{rd} party test, RCOICS 100 seamlessly integrates the Internet available 3^{rd} party test into its own system. Thus, in one embodiment, the RCOICS 100 may appear to generate the 3^{rd} party test, while the test is actually generated by a 3^{rd} party testing vendor. In one embodiment, the tests are designed directly into RCOICS 100. In one embodiment, the tests are available over a network like the Internet and separate from RCOICS 100. RCOICS 100 can be configured to import the test results when available.

In one embodiment, RCOICS 100 includes test templates that form tests for testing agent 140 to administer. In one embodiment, a test template can be constructed by adding at least one testable skill category to the test template. In one embodiment, a user (i.e., a recruiter) can create at least one test template that is only administered by testing agent 140 for the user. In one embodiment, RCOICS 100 enables a user to create a global test template. In one embodiment, RCOICS 100 enables a predefined set of users to access the test template. In an alternative embodiment, RCOICS 100 enables every user to access the global test template.

In one embodiment, RCOICS 100 enables a test administrator to add testable skill categories. However, in one embodiment, RCOICS 100 can enable any suitable person to add testable skill categories. In one embodiment, RCOICS 100 limits the testable skill categories to recognized skills and abilities. In one embodiment, the testable skill categories are based on skills that are learned by the job agent 110 and candidate agent 120. In one embodiment, a skill on a global skills list may trigger testing agent 140 to test for these skills. In one embodiment, job agent 110 or candidate agent 120 pushes certain popular skills to testing agent 140. However, in one embodiment, the popular skills or global skills are stored in a database where testing agent 140 can retrieve a list of the most popular skills for testing. In one embodiment, if testing agent 140 tests for a certain skill, RCOICS 100 prohibits the skill from being removed from the system. However, it should be appreciated that in one embodiment, a skill can be deleted even if testing agent 140 can still administer a test using the deleted skill. It should also be appreciated that in one embodiment, RCOICS 100 can include any suitable testable skill category even if the skill or ability is not yet recognized.

In one embodiment, a testable skill category includes a pool of questions related the skill category. For example, in one embodiment, a testable skill category called “developer—general concepts” may ask about a candidate about programming concepts common to every programming language. Similarly, a testable skill category called “Developer—.Net™” would ask a candidate specific questions related to programming the .NET™ programming environment, a category called “Developer—.Net 2.0™” would deal with enhancements in the 2.0 framework, or “PMP certified project management” to deal with project management. In one embodiment, a test template can include testable skills from a plurality of skill categories. Thus, in one embodiment, a user could create a test template for a “Senior .NET™ developer” test, using 10 questions from a “developer—general concepts” category, 20 Questions from a “Developer—.Net™” category and 20 Questions from a “Developer—Net 2.0™” category. Similarly, a user could create a test template for a project manager that can lead a group Net™ project by creating a test template that includes 25 questions from “PMP certified project management”, 5 from “Developer—.Net™” and 10 from “Developer—.Net 2.0™.”

In one embodiment, RCOICS 100 enables a test administrator to create/add test questions associated with at least one test category to RCOICS 100. In one embodiment, RCOICS 100 enables any user to create/add test questions associated with at least one test category to RCOICS 100. In one embodiment, test questions can be submitted by any one that works for a company that is advertising a job opportunity. In one embodiment, RCOICS 100 enables anyone in the public or a person skilled in a testable skill category to create/add test questions to RCOICS 100. In one embodiment, any test questions can be rejected, accepted, edited and deleted, enabled and disabled by authorized test administrators.

In one embodiment, RCOICS 100 includes at least three types of questions (e.g., multiple choice, true/false, and fill in the blank questions). In one embodiment, multiple choice questions include between 2 and 10 answers; however the multiple choice questions can include any suitable number of answers. In one embodiment, true/false questions have one question to which the answer must be true or false. In one embodiment, fill in the blank questions do not provide answers, but enable a user to provide a unscripted answer. For example, a fill in the blank question may include a question such as “Tell me about your biggest challenge in project management”. The question does not include a correct answer, but rather the answer will be subjectively graded based on a response that shows a predetermined depth of knowledge. However, it should be appreciated that in one embodiment, fill in the blank questions can include any suitable question. In one embodiment, questions can require an answer that may be absolute or relative. That is, absolute answers include either a right or wrong answer while relative answers allow percentages to be assigned to questions. Thus, in one embodiment, RCOICS 100 can award a tested candidate credit for providing a similar or mostly correct answer.

In one embodiment, when testing agent 140 administers a test, testing agent 140 may limit the time a user has to answer a question. In one embodiment, testing agent 140 displays a countdown on the test page. In one embodiment, testing agent 140 may not limit the time a user has to answer a question. In one embodiment, each time the test taker answers a question, testing agent 140 provides a new question from a list of questions that form the test. In one embodiment, testing agent 140 prevents a candidate from returning to a previously answered test question or changing a response to a test question once the question is answered. However, it should be appreciated that in one embodiment, testing agent 140 can enable a candidate to return to a previously answered test question and make any suitable changes.

In one embodiment, after testing agent 140 administers at least one test to at least one candidate, RCOICS 100 can provide a user (i.e., a recruiter) the test results. In one embodiment, RCOICS 100 waits until all candidates have been tested for a job opportunity before providing the test results to the user. However, it should be appreciated that the RCOICS 100 can provide the test results at any suitable time. In one embodiment, RCOICS 100 ranks of all the candidates that sat for a test for a particular job opportunity. Thus, RCOICS 100 can further narrow the viable qualified candidates for a job opportunity and enable the recruiter to select the candidates that best fit the job opportunity.

In one embodiment, testing agent 140, like many of the components of RCOICS 100, can be configured from system feedback. That is, like job agent 110, testing agent 140 can learn and modify what questions should be offered to candidates. In one embodiment, if testing agent 140 determines that many or all candidates consistently provide an incorrect answer to an offered question, testing agent 140 may discontinue offering the question. Similarly, if testing agent 140 determines that many or all candidates consistently provide a correct answer to an offered question, testing agent may discontinue offering the question because it does not resolve any skill differences between the candidates. In one embodiment, testing agent 140 tracks the questions offered and how often candidates correctly answer the questions. Thus, in one embodiment, as more data is gathered about a question over time, the testing agent 140 can rank its questions against each other for difficulty depending on the number of candidates that answered the question correctly or incorrectly.

Turning now to FIG. 4, one embodiment of a recruiting system generating a pool of viable qualified candidates is illustrated. At block 300, the recruiting system is configured to obtain information about at least one job opportunity. The at least one job opportunity includes at least one job requirement. At block 302, the recruiting system generates a first pool of potentially viable candidates for the job opportunity by comparing information extracted from any available candidate resumes to the at least one job requirement. If a resume included at least one skill that matched the at least one job requirement, the candidate resume is added to the pool of potentially viable candidates. However, as described above, the job opportunity may require that a candidate resume include more than one matching job requirement to be included in the pool of potentially viable candidates. In one embodiment, at block 304, recruiting system 304 selects and adds at least one candidate from the pool of potentially viable candidates to a second pool of more viable candidates. The recruiting system selects at least one candidate from the second pool to contact.

At block 306, recruiting system enables the at least one contacted candidate to opt-in to receive more information about or apply for the job opportunity. As described above, recruiting system is configured to accept any suitable type of response from the user, depending on the manner the recruiting system contacted the candidate. If the at least one candidate did not opt-in at block 308, recruiting system goes to block 312 to determine if any candidates from the first pool of potentially viable candidates are still available. If any candidates are still available, the recruiting system returns to block 304 to select at least one additional candidate from the first pool of candidates. If no candidates are still available, recruiting system jumps to block 314. In one embodiment, if no candidates opted in, the process ends.

Returning to block 308, if the at least one candidate opted-in, the candidate is added to a third pool of available and willing candidates as shown at block 310. At block 312, the recruiting system determines if additional job candidates are still left in the pool of potentially viable candidates. If any candidates remain in the pool of potentially viable candidates, then recruiting system returns to block 304. If no candidates remain in the pool of potentially viable candidates, then the recruiting system administers at least one test to the at least one candidate from the third pool of available and willing candidates at block 314. In one embodiment, if no candidates opted in, the process ends and no candidates are tested. As described above, the recruiting system can test candidates for any suitable skill as required by the job opportunity.

At block 316, the recruiting system determines if the at least one available and willing job candidate passed the administered test. If the at least one available and willing candidate did not pass the test, the recruiting system jumps to block 320 to determine if any candidates remain in the third pool of available and willing candidates. If no candidates remain, then the recruiting system generates a list of viable qualified candidates. If any candidates remain, then the recruiting system returns to block 314.

If the at least one available and willing candidate passed the test, the recruiting system adds the at least one available and willing candidate to a fourth pool of viable qualified candidates at block 318. At block 320, recruiting system determines if any candidates remain in the third pool of available and willing candidates. If any candidates remain, then the recruiting system returns to block 314. If no candidates remain, then the recruiting system generates a list of viable qualified candidates based on the candidates in the fourth pool of candidates.

Turning to FIG. 5, one embodiment of the recruiting system illustrates the flow of how a candidate pool is narrowed to at least one chosen candidate. In one embodiment, the recruiting system enables a recruiter to engage the recruiting process at any point. If the recruiter elects to engage in the process further along in the selection process, the recruiter can minimize the amount of work the recruiter needs to perform. A recruiter can produce significant time savings by engaging in the process when candidate pool levels have been more narrowly defined.

At block 400, the system starts with job requirements and unfiltered candidate resumes (e.g., a raw pool of candidate resumes) that exist in job databanks. At block 410, the recruiting system can parse job requirements and generate the at least one first pool automatically or a recruiter can engage the process at this level. In one embodiment, the recruiting system maximizes the effectiveness of each search by searching multiple resume sources. In one embodiment, if the recruiting system performs multiple searches with skills combinations and synonyms, the recruiting system can produce a diverse targeted list (i.e., a diverse targeted list of potentially viable candidates).

At block 420, the recruiting system creates a second pool of selected potentially viable candidates, based on a further examination of the resumes returned to the recruiting system. In one embodiment, the recruiting system can select at least one candidate automatically, or a recruiter can review and select the at least one candidate to be contacted. In one embodiment, the recruiting system selects as many potentially viable candidates as possible. The recruiting system lets the candidate decide if the candidate wants to pursue the job opportunity because it is better to find an available and willing candidate, who is the best match for the job, than to eliminate them based on a resume emphasizing different skills.

At block 430, the recruiting system creates a third pool of available and willing candidates that have self identified by opting-in as having the availability, desire, skills and abilities to do a specific job. In one embodiment, this stage of the process is a desirable point for a recruiter to engage the process, as the first point of contact has occurred. In one embodiment, this stage of the process can include a 50:1 reduction on candidates from the second pool. In one embodiment of the recruiting system, a recruiter may specify the system to present them with a desired quantity of available and willing candidates or specify a specific time for the system to keep searching, and present available and willing candidates that have been found, or see a list of opted-in candidates that were manually selected for the opt-in process at the stage when then second pool is created. In one embodiment, the recruiting system contacts every potentially viable candidate that opted-in for the specific job. In one embodiment, even if a candidate is determined to not be suitable for a specific job, they may be pipelined or assessed as a desirable asset and have a recruiter assigned to them.

At block 440, the recruiting system can apply a validation process to the candidates from the third pool. In one embodiment, the qualification of an available and willing candidate may be passing a criminal background check, a skills test, a drug test, language comprehension, or simply an interview with the recruiter, or any combination of these. In one embodiment, certain validation processes can be automated, such as background checks and skills testing. In one such embodiment, a recruiter can select to engage the process at the level of qualified viable candidates.

It should therefore be appreciated that the recruiting system disclosed herein enables recruiters to focus on the most viable qualified candidates for a job. Recruiters no longer spend hours reading large volumes of resumes to find the most suitable resumes only to find that selected candidates are not interested or are not available. The recruiting system enables the recruiter maximize their productive by working to place candidates that are interested, available and qualified for a specific job opportunity.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for determining relevant candidates for at least one job opportunity, the method comprising:
(a) generating at least one first pool of potentially viable candidates based on a comparison between at least one job opportunity and candidate resumes, wherein the job opportunity includes at least one job criterion;
(c) selecting and contacting at least one candidate from the at least one first pool of potentially viable candidates;
(d) enabling the at least one selected potentially viable candidate to opt-in to receive information about the at least one job opportunity; and
(e) adding the at least one selected potentially viable candidate to a second pool of available and willing candidates if the selected potentially viable candidate opted to receive more information about the at least one job opportunity.

2. The method of claim 1, further comprising repeating steps (c) to (f) until each candidate in the at least one first pool of potentially viable candidates was contacted at least once.

3. The method of claim 1, further comprising enabling each candidate in the pool of candidates to undergo at least one verification process to determine if each candidate is a qualified candidate for the job opportunity.

4. The method of claim 3, wherein the at least one verification process enables the candidate to verify information stored on the candidate.

5. The method of claim 3, wherein the at least one verification process enables the candidate to participate in a test of knowledge.

6. The method of claim 5, wherein the test of knowledge is based on job requirements associated with the job opportunity.

7. The method of claim 2, further comprising adding each candidate that passed the at least one verification process to a third pool of candidates.

8. The method of claim 1, wherein the pool of candidates is generated from searching at least one data collection.

9. The method of claim 8, wherein the data collection is at least one database.

10. The method of claim 9, wherein the at least one database is accessed over a network.

11. The method of claim 8, further comprising determining and storing at least a portion of a candidate's resume from the at least one data collection.

12. The method of claim 1, wherein the job opportunity is selected from at least one data collection.

13. The method of claim 12, wherein the data collection is at least one database.

14. The method of claim 13, wherein the at least one database is accessed over a network.

15. The method of claim 14, wherein the job opportunity is selected from one of the following:
a) at least one publicly accessible job database;
b) at least one privately accessible job database; and
c) a combination of at least one publicly accessible job database and at least one privately accessible job database.

16. The method of claim 1, wherein the at least one candidate is contacted by telephone or through the Internet.

17. The method of claim 16, further comprising enabling the candidate to opt-in for more information by providing a telephone response or an Internet based response.

18. The method of claim 17, wherein the candidate opts-in for more information through a telephone response by providing one of the following:
a) selecting a predetermined button on the telephone; or
b) providing a predetermined voice response over the telephone.

19. The method of claim 17, wherein the candidate opts-in for more information through an Internet based response by providing one of the following:
a) sending an email reply; or
b) visiting a website and requesting additional information.

20. A system for determining relevant candidates for at least one job opportunity comprising:
a job agent, wherein the job agent selects at least one job opportunity, wherein the job opportunity is associated with at least one job criterion;
a job candidate selection agent, wherein the candidate selection agent generates at least one first pool of potentially viable job candidates based on the at least one job criterion;
an opt-in confirmation agent, wherein the opt-in confirmation agent contacts at least one job candidate from the at least one first pool of potentially viable job candidates and enables the at least one contacted job candidate to opt-in to receive additional information about the at least one job opportunity, wherein the opt-in confirmation agent adds each potentially viable job candidate that opted-in to a second pool of available and willing job candidates; and
a report agent, wherein the report agent generates at least one report based on the job candidates that form the second pool of available and willing job candidates.
